(19) United States
(12) Patent Application Publication
(10) Pub. No.: US 2025/0276896 A1
(43) Pub. Date: Sep. 4, 2025

(54) PROCESS FOR THE PRODUCTION OF HYDROGEN-ENRICHED SYNTHESIS GAS

(71) Applicant: Arkema France, Colombes (FR)

(72) Inventors: Francis Humblot, Lanneplaa (FR); Paul Guillaume Schmitt, Lescar (FR)

(73) Assignee: Arkema France, Colombes (FR)

(21) Appl. No.: 18/980,719

(22) Filed: Dec. 13, 2024

Related U.S. Application Data
(63) Continuation of application No. 16/084,725, filed on Sep. 13, 2018, now abandoned.

(30) Foreign Application Priority Data
Mar. 17, 2016 (FR) 1652291

(51) Int. Cl. C01B 3/16; C01B 3/48

(52) U.S. Cl. CPC C01B 3/16; C01B 3/48; C01B 2203/0227; C01B 2203/025; C01B 2203/0283

(57) ABSTRACT

Provided is a process for the production of hydrogen-enriched synthesis gas by a catalytic water-gas shift reaction operated on a raw synthesis gas. The reaction is carried out in the presence of at least one compound of formula (I):

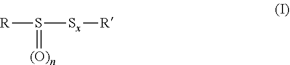

where the structural variable as are defined herein.

### CROSS REFERENCE TO RELATED APPLICATIONS

This application is a continuation of U.S. application Ser. No. 16/084,725, filed Sep. 13, 2018, which is the U.S. National Phase Application of PCT/FR2017/050575, filed Mar. 14, 2017, which claims priority to French Application No. FR 1652291, filed Mar. 17, 2016, the disclosures of these applications being incorporated herein by reference in their entireties for all purposes.

### FIELD OF THE INVENTION

The present invention relates to a process for the production of hydrogen-enriched synthesis gas by a catalytic water-gas shift reaction operated on a raw synthesis gas.

### BACKGROUND OF THE INVENTION

Synthesis gas, or briefly syngas, is a combustible gas mixture comprising carbon monoxide and hydrogen, and optionally other gases, such as carbon dioxide, nitrogen and water, hydrocarbons (e.g. methane), rare gases (e.g. argon), nitrogen derivatives (e.g. ammonia, hydrocyanic acid), etc. Synthesis gas can be produced from many sources, including natural gas, coal, biomass, or virtually any hydrocarbon feedstock, by reaction with steam or oxygen. Synthesis gas is a versatile intermediate resource for production of hydrogen, ammonia, methanol, and synthetic hydrocarbon fuels.

Various processes are commonly used in the industry for the production of synthesis gas, mainly:
Steam Methane Reforming (SMR) or steam reforming for conversion of methane mainly. The resulting synthesis gas contains no sulfur compounds;
Gasification or partial oxidation (POx) which can also be catalytic (CPOx) is mainly used for the conversion of heavy feedstocks such as naphtha, liquefied petroleum gas, heavy fuel oil, coke, coal, biomass . . . The resulting synthesis gas may be particularly rich in sulfur-containing components, mainly hydrogen sulphide.

Steam can be added to the synthesis gas in order to produce higher amount of hydrogen according to the well-known water-gas shift reaction (WGSR) which may be carried out to partially or totally eliminate carbon monoxide by converting it to carbon dioxide:

H₂O_{(g)}+CO_{(g)} [symbol] CO_{2(g)}+H_{2(g)}

wherein (g) indicates gaseous form.

The water-gas shift reaction is a reversible, exothermic chemical reaction highly used in the industry.

This reaction may be catalyzed in order to be carried out within a reasonable temperature range, typically less than 500° C. The type of catalysts usually employed depends on the sulfur content of the synthesis gas to be treated. Thus, the water-gas shift catalysts are generally classified into two categories, as described by David S. Newsome in Catal. Rev.-Sci. Eng., 21 (2), pp. 275-318 (1980):
iron-based or copper-based shift catalysts, also called “sweet shift catalysts”, are used with a sulfur-free synthesis gas (after a SMR for example) due to their deactivation by sulfur;
cobalt and molybdenum-based shift catalysts, also called “sulfur-resistant shift catalysts” or “sour shift catalysts”, which are used with a sulfur-containing synthesis gas (obtained after a coal gasification for example). These catalysts are often doped with an alkali metal such as sodium, potassium or caesium.

The main difference between sweet shift catalysts and sulfur-resistant shift catalysts is that the latter are active in their sulphided form and therefore need to be pre-sulphided prior to use. The sulfur-resistant shift catalysts are thus generally completely sulphided in their most active form. Thus, these catalysts are not only sulfur-tolerant but their activity may actually be enhanced by the sulfur present in the feed to be treated.

The sulfur-resistant shift catalysts have been widely developed in recent years. Indeed, the amount of fossil fuels, mainly natural gas and oil, has been continuously diminished and many researchers have focused their studies on the development of processes using less noble carbon sources such as coal or biomass which are usually particularly rich in sulfur. The synthesis gas obtained from these carbon sources generally contains hydrogen sulphide (H₂S) and carbonyl sulphide (COS) which may activate and maintain the activity of the sulfur-resistant shift catalysts during the further processed water-gas shift reaction.

However, some synthesis gases do not contain a sufficient amount of sulfur-containing compounds due to the low sulfur contents in the initial carbonaceous feedstock. Indeed, the (endogenous) sulfur content of the synthesis gases depends mainly on the coal type and the coal origin as indicated in Table 1.

TABLE 1
typical properties for characteristic coal types

| | Energy content, kJ/g | Sulfur |
|---|---|---|
| Coal Type | (carbon content, wt %) | (wt %) |
| Bituminous | 27,900 (avg. consumed in U.S.) | 2-4 |
| | 67% | |
| Sub-bituminous | 20,000 (avg. consumed in U.S.) | 0.5-0.5 |
| (Powder River Basin) | 49% | |
| Lignite | 15,000 (avg. consumed in U.S.) | 0.6-1.6 |
| | 40% | |
| Average Chinese Coal | 19,000-25,000 | 0.4-3.7 |
| | 48-61% | |
| Average Indian Coal | 13,000-21,000 | 0.2-0.7 |
| | 30-50% | |

Hydrogen sulphide (H₂S) is the main source of sulfur in a synthesis gas obtained after gasification. For a synthesis gas with an insufficient sulfur content, the addition of extra hydrogen sulphide (exogenous hydrogen sulphide) is generally performed to efficiently activate the sulfur-resistant shift catalyst. Indeed, addition of H₂S to a mixture of CO and H₂O considerably enhances formation of H₂ and CO₂, as described by Stenberg et al. in Angew. Chem. Int. Ed. Engl., 21 (1982) No. 8, pp 619-620.

However, hydrogen sulphide has the inconvenient of being a highly toxic and flammable gaseous compound that manufacturers try to avoid.

It would therefore be desirable to use another activating agent which is easier to handle and safer to use than hydrogen sulphide, while being as effective as hydrogen sulphide to activate the sulfur-resistant shift catalysts and maintain their activity.

It is an objective of the present invention to develop a safer process for the water-gas shift reaction from a sulfur-containing synthesis gas.

Another objective of the present invention is the implementation of an industrial-scale process for the water-gas shift reaction from a sulfur-containing synthesis gas.

### SUMMARY OF THE INVENTION

A first object of the invention is a process for the production of hydrogen-enriched synthesis gas by a catalytic water-gas shift reaction operated on a raw synthesis gas, said reaction being carried out in the presence of at least one compound of formula (I):

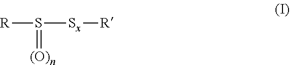

in which:
R is selected from a linear or branched alkyl radical containing from 1 to 4 carbon atoms, and a linear or branched alkenyl radical containing from 2 to 4 carbon atoms,
n is equal to 0, 1 or 2,
x is an integer selected from 0, 1, 2, 3 or 4,
R′ is selected from a linear or branched alkyl radical containing from 1 to 4 carbon atoms, a linear or branched alkenyl radical containing from 2 to 4 carbon atoms and, only when n=x=0, a hydrogen atom.

According to a preferred embodiment, the compound of formula (I) is selected from dimethyl disulphide and dimethyl sulfoxide, preferably dimethyl disulphide.

According to an embodiment, the catalytic water-gas shift reaction is carried out in a reactor with an inlet gas temperature of at least 260° C., preferably ranging from 280° C. to 330° C.

According to an embodiment, the compound of formula (I) is continuously injected at a flow rate of 0.1 Nl/h to 10 Nm³/h.

According to an embodiment, the catalytic water-gas shift reaction is carried out in the presence of a sulfur-resistant shift catalyst, preferably a cobalt and molybdenum-based catalyst.

Preferably, the sulfur-resistant shift catalyst comprises an alkali metal, preferably selected from sodium, potassium or caesium.

According to an embodiment, the catalytic water-gas shift reaction is carried out at a pressure of at least 10 bar, preferably ranging from 10 to 30 bar.

According to an embodiment, the raw synthesis gas comprises water and carbon monoxide in a molar ratio of water to carbon monoxide of at least 1, preferably at least 1.2, more preferably at least 1.4.

Preferably, the residence time in the reactor ranges from 20 to 60 seconds.

Another object of the invention is the use of at least one compound of formula (I):

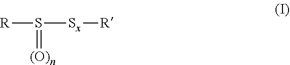

in which:
R is selected from a linear or branched alkyl radical containing from 1 to 4 carbon atoms, and a linear or branched alkenyl radical containing from 2 to 4 carbon atoms,
n is equal to 0, 1 or 2,
x is an integer selected from 0, 1, 2, 3 or 4,
R′ is selected from a linear or branched alkyl radical containing from 1 to 4 carbon atoms, and a linear or branched alkenyl radical containing from 2 to 4 carbon atoms and, only when n=x=0, a hydrogen atom, in a catalytic water-gas shift reaction for activating a sulfur-resistant shift catalyst.

According to a preferred embodiment, dimethyl disulphide and dimethyl sulfoxide, preferably dimethyl disulphide, are used for activating a sulfur-resistant shift catalyst in a catalytic water-gas shift reaction.

It has now surprisingly been found that the use of compound(s) of formula (I) is particularly effective as an activating agent of sulfur-resistant shift catalysts instead of hydrogen sulphide.

Moreover, compounds of formula (I) are generally presented in liquid form, which greatly facilitates their handling and the measures to be taken for the safety of the operators.

As another advantage, the process of the invention allows conversion of CO to CO₂.

Furthermore, the process of the invention is suitable with respect to the requirements regarding the security and the environment.

### DETAILED DESCRIPTION OF THE INVENTION

The invention relates to a process for the production of hydrogen-enriched synthesis gas by a catalytic water-gas shift reaction operated on a raw synthesis gas, said reaction being carried out in the presence of at least one compound of formula (I):

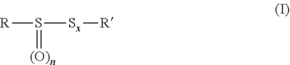

in which:
R is selected from a linear or branched alkyl radical containing from 1 to 4 carbon atoms, and a linear or branched alkenyl radical containing from 2 to 4 carbon atoms,
n is equal to 0, 1 or 2,
x is an integer selected from 0, 1, 2, 3 or 4,
R′ is selected from a linear or branched alkyl radical containing from 1 to 4 carbon atoms, a linear or branched alkenyl radical containing from 2 to 4 carbon atoms and, only when n=x=0, a hydrogen atom.

The raw synthesis gas is typically obtained after a gasification step of a raw material such as coke, coal, biomass, naphtha, liquefied petroleum gas, heavy fuel oil. The production of synthesis gas is well known in the state of the art. The raw synthesis gas may also be obtained from a Steam Methane Reformer.

According to the present invention, the raw synthesis gas comprises carbon monoxide, and optionally other gases, such as hydrogen, carbon dioxide, nitrogen and water, hydrocarbons (e.g. methane), rare gases (e.g. argon), nitrogen derivatives (e.g. ammonia, hydrocyanic acid), etc.

According to an embodiment of the invention, the raw synthesis gas comprises carbon monoxide and hydrogen, and optionally other gases such as carbon dioxide, nitrogen and water, hydrocarbons (e.g. methane), rare gases (e.g. argon), nitrogen derivatives (e.g. ammonia, hydrocyanic acid), etc.

According to another embodiment of the invention, the raw synthesis gas comprises carbon monoxide, carbon dioxide, hydrogen, nitrogen and water.

The raw synthesis gas may also comprise sulfur-containing components. In this case, the raw synthesis gas may comprise carbon monoxide, carbon dioxide, hydrogen, nitrogen and water as main components and sulfur-containing components in lower concentrations. The sulfur-containing components may be hydrogen sulphide, carbonyl sulphide. Typical (endogenous) sulfur content in the raw synthesis gas ranges from about 20 to about 50,000 ppmv. Typical (endogenous) sulfur content in the raw synthesis gas may depend on the raw material initially used for the production of the raw synthesis gas.

In an embodiment of the invention, the water-gas shift reaction is carried out in a catalytic reactor, preferably in a fixed bed catalytic reactor.

The water-gas shift reaction consists in the conversion of carbon monoxide and water contained in the raw synthesis gas to carbon dioxide and hydrogen according to equation (1):

H₂O_{(g)}+CO_{(g)} [symbol] CO_{2(g)}+H_{2(g)} (1)

wherein (g) indicates gaseous form.

This water-gas shift reaction allows to obtain a hydrogen-enriched synthesis gas. By “hydrogen-enriched synthesis gas” according to the present invention, it is to be understood that the synthesis gas at the outlet of the process of the invention comprises more hydrogen than the synthesis gas at the inlet of the process of the invention. In other words, the proportion of hydrogen in the gas at the outlet of the process is higher than the proportion of hydrogen in the gas at the outlet of the process.

According to an embodiment of the invention, water may be added to the raw synthesis gas. Introduction of additional (exogenous) water allows to shift the equilibrium to the formation of carbon dioxide and hydrogen. Additional (exogenous) water may be introduced either directly to the reactor or in a mixture with the raw synthesis gas.

The efficiency of water-gas shift reaction and thus of the hydrogen enrichment of the synthesis gas may be measured directly by hydrogen purity analysis, for instance with a gas chromatograph. It could also be indirectly measured by determining the CO conversion in CO₂ meaning that the water-gas shift reaction has occurred. The CO conversion into CO₂ is known by measuring the CO conversion and the CO₂ yield.

In an embodiment of the invention, the molar ratio of water to carbon monoxide in the gas entering the water-gas shift reaction is of at least 1, preferably at least 1.2, more preferably at least 1.4, advantageously at least 1.5. The molar ratio of water to carbon monoxide may range from 1 to 3, preferably from 1.2 to 2.5, more preferably from 1.5 to 2.

In an embodiment of the invention, catalysts suitable for use in the water-gas shift reaction are sulfur-resistant shift catalysts. By “sulfur-resistant shift catalyst” is meant a compound capable of catalyzing the water-gas shift reaction in the presence of sulfur-containing components.

Catalysts suitable for use in the water-gas shift reaction may comprise at least one transition metal other than iron and copper, preferably selected from the group consisting of molybdenum, cobalt and nickel. A combination of at least two of these transition metals is preferably used, such as cobalt and molybdenum, or nickel and molybdenum, more preferably cobalt and molybdenum.

The catalysts according to the invention may be either supported or unsupported, preferably supported. Suitable catalyst supports may be alumina.

In a preferred embodiment, the catalyst also comprises an alkali metal selected from the group consisting of sodium, potassium and caesium, preferably potassium and caesium, or salts thereof. An example of a particularly active catalyst is the combination of caesium carbonate, caesium acetate, potassium carbonate or potassium acetate, together with cobalt and molybdenum.

As an example of suitable catalysts according to the invention, mention may be made of sulfur-resistant shift catalysts, such as those disclosed by Park et al. in “A Study on the Sulfur-Resistant Catalysts for Water Gas Shift Reaction-IV. Modification of CoMo/γ-Al2O3 Catalyst with Iron Group Metals”, Bull. Korean Chem. Soc. (2000), Vol. 21, No. 12, 1239-1244.

The process according to the invention makes use of at least one compound of formula (I) as activating agent:

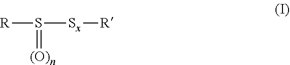

in which:
R is selected from a linear or branched alkyl radical containing from 1 to 4 carbon atoms, and a linear or branched alkenyl radical containing from 2 to 4 carbon atoms,
n is equal to 0, 1 or 2,
x is an integer selected from 0, 1, 2, 3 or 4,
R′ is selected from a linear or branched alkyl radical containing from 1 to 4 carbon atoms, a linear or branched alkenyl radical containing from 2 to 4 carbon atoms and, only when n=x=0, a hydrogen atom.

According to one embodiment, the compound of formula (I) that may be used in the process of the present invention is an organic sulphide, optionally in its oxide form (when n is different from zero), obtained according to any process known per se, or else commercially available, optionally containing a reduced amount of, or no, impurities that may be responsible for undesired smells, or optionally containing one or more odor-masking agents (see for example WO2011012815A1).

Among preferred R and R′ radicals, mention may be made of methyl, propyl, allyl and 1-propenyl radicals.

According to an embodiment of the invention, in the above formula (I), x represents 1, 2, 3 or 4, preferably x represents 1 or 2, more preferably x represents 1.

According to a preferred embodiment, the compound of formula (I) for use in the process of the present invention is a compound of formula (Ia):

R—S—Sₓ—R′ (Ia)

which corresponds to formula (I) wherein n is equal to 0, and R, R′ and x are as defined above.

Preferably, the compound of formula (Ia) is dimethyl disulphide (“DMDS”).

According to a preferred embodiment of the invention, the compound of formula (I) useful in the present invention is a compound of formula (Ib):

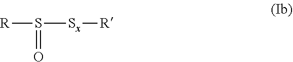

which corresponds to formula (I) wherein n is equal to 1, and R, R′ and x are as defined above.

Preferably, the compound of formula (Ib) is dimethyl sulfoxide (“DMSO”).

It should be understood that mixtures of two or more compounds of formula (I) may be used in the process of the present invention. Especially mixtures of di- and/or polysulphides may be used, for example mixtures of disulphides, such as disulphide oils (“DSO”).

In an embodiment of the invention, the compound(s) of formula (I) is (are) added upstream of the reactor to the raw synthesis gas flow and the resulting mixture is preferably continuously injected into the reactor. The concentration of compound(s) of formula (I) into the raw synthesis gas flow may range from 100 to 500,000 ppmv, preferably from 100 to 200,000 ppmv, more preferably from 100 to 100,000 ppmv. The flow rate of compound(s) of formula (I), preferably of dimethyl disulphide, may range from 1 Nl/h to 10 Nm³/h.

In an embodiment of the invention, the gas entering the water-gas shift reaction is pre-heated to a temperature of at least 260° C. In a preferred embodiment, this temperature ranges from 280° C. to 330° C., preferably from 290° C. to 330° C., more preferably 310° C.

The water-gas shift reaction step can be carried out with a minimal inlet gas temperature of 260° C. An inlet gas temperature of at least 260° C. allows to improve the conversion of carbon monoxide to carbon dioxide.

In an embodiment of the invention, the pressure for the water-gas shift reaction step is of at least 10 bars (1 MPa), preferably ranges from 10 to 30 bars (1 MPa à 3 MPa), more preferably from 15 to 25 bars (1.5 MPa to 2.5 MPa).

In an embodiment of the invention, the residence time in the reactor ranges from 20 to 60 seconds, preferably from 30 to 50 seconds, allowing the determination of the amount of catalyst in the reactor. The residence time is defined by the following formula:

$$residence time = \frac{{V}_{cat}}{{D}_{gas}} \times \frac{{P}_{reac}}{{P}_{atm}}$$

wherein V_{cat} represents the volume of catalyst in the reactor expressed in m³, D_{gas} represents the inlet gas flow rate expressed in Nm³/h, P_{reac} and Pₐₜₘ respectively represent the pressure in the reactor and the atmospheric pressure expressed in Pa.

In an embodiment of the invention, the CO conversion rate of the water-gas shift reaction is of at least 50%, preferably at least 60%, more preferably at least 65%. The CO conversion rate is calculated as follows:

$$CO Conversion ( \% ) = \frac{( Q \cdot {CO}_{entry} - Q \cdot {CO}_{exit} )}{Q \cdot {CO}_{entry}} \times 100$$

wherein Q.CO_{entry} represents the molar flow of CO at the inlet of the reactor expressed in mol/h and Q.COₑₓᵢₜ represents the molar flow of CO at the outlet of the reactor expressed in mol/h.

In an embodiment of the invention, the CO₂ yield of the water-gas shift reaction is of at least 50%, preferably at least 60%, more preferably at least 65%.

The CO₂ yield rate is calculated as follows:

$${CO}_{2} yield ( \% ) = \frac{( Q \cdot {CO}_{2 {,}_{exit}} )}{( Q \cdot {CO}_{entry} )} \times 100$$

wherein Q.CO_{entry} represents the molar flow of CO at the inlet of the reactor expressed in mol/h and Q.CO₂, exit represents the molar flow of CO₂ at the outlet of the reactor expressed in mol/h.

In a preferred embodiment of the invention, the reactor comprising the catalyst may be filled with an inert material to allow an efficient distribution of the gas into the reactor before starting up the reactor for the water-gas shift reaction step. Suitable inert materials may be silicon carbide or alumina. Advantageously, the catalyst and the inert material are placed in successive layers into the reactor.

In a preferred embodiment of the invention, a preparation step of the catalyst is performed before the water-gas shift reaction step. The preparation step of the catalyst may include a drying step and/or a pre-activation step, preferably a drying step and a pre-activation step.

During the drying step, the catalyst may be dried under an inert gas flow, preferably a nitrogen gas flow. The inert gas flow rate may range from 0.1 to 10,000 Nm³/h. During the drying step, the temperature may increase from 20° C. to 200° C. The drying time may range from 1 to 10 hours, preferably 6 hours. The drying step is preferentially performed from ambient pressure to the preferred operated pressure between 15 to 25 bars.

During the pre-activation step, the catalyst may be sulphided. The reactor may be treated under a hydrogen stream at a flow rate of 0.1 to 10,000 Nm³/h and at a pressure of, at least, the preferred operated pressure between 15 to 25 bars (1.5 MPa to 2.5 MPa). Then, hydrogen sulphide and/or compound(s) of formula (I), typically dimethyl disulphide, may be injected upflow at a flow rate of 1 Nl/h to 10 Nm³/h into the hydrogen stream. The temperature may then be increased from 150° C. to 350° C. by any means known to the person skilled in the art. The time of pre-activation step may range from one to several hours, generally from 1 to 64 hours. The hydrogen stream is preferably maintained during all the pre-activation step.

Another object of the invention relates to the use of at least one compound of formula (I) in a catalytic water-gas shift reaction for activating a sulfur-resistant shift catalyst.

In an embodiment of the invention, the catalytic water-gas shift reaction using at least one compound of formula (I) for activating a sulfur-resistant shift catalyst is carried out in a reactor. The gas entering said reactor is advantageously heated to a temperature of at least 260° C.

### Examples

A water-gas shift reaction is carried out in a catalytic reactor A of a pilot plant according to the following procedure.

### 1) Preparation of Catalytic Reactor A

Catalytic reactor A of 150 cm³ is filled at ambient pressure and ambient temperature with three layers of solids separated by metal grids, as follows:
a first layer of 60 cm³ of silicon carbide of Carborundum type having a particle size of 1.680 mm: this inert material allows a satisfactory gas distribution,
a second layer of 40 cm³ of a CoMo-based sulfur-resistant shift catalyst,
a third layer of 50 cm³ of silicon carbide of Carborundum type having a particle size of 1.680 mm.

Catalytic reactor A is then positioned into a furnace that can withstand a wide temperature range from 100° C. to 350° C. Catalytic reactor A is connected at the inlet tubing to a gas feed and at the outlet tubing to an analyzer.

For the example, the CoMo-based sulfur-resistant shift catalyst is first dried by a nitrogen flow rate of 20 Nl/h at ambient pressure. The drying temperature is set to 150° C. with a temperature ramp of +25° C./h. The drying time is set to 1 hour.

A second step consists in sulfiding the CoMo-based sulfur-resistant shift catalyst to pre-activate it. During this step, the reactor is treated under a hydrogen flow rate of 20 Nl/h at a pressure of 35 bars (3.5 MPa). Then hydrogen sulphide is injected upflow at a flow rate of 0.5 Nl/h into the hydrogen feed. The catalyst is then subjected to a temperature ramp of 20° C./h. The first plateau is set to 150° C. for 2 hours then the temperature is increased up to 230° C. with a temperature ramp of +25° C./h. A second plateau of 4 hours is maintained to 230° C. and then the temperature is increased again up to 350° C. with a temperature ramp of +25° C./h. A final plateau of 16 hours is performed at 350° C. The temperature was then dropped to 230° C. still under a hydrogen stream with a flow rate of 20 Nl/h: the catalyst is thus pre-activated.

### 2) Water-Gas Shift Reaction Step

The study of the conversion of carbon monoxide to carbon dioxide in the pre-activated CoMo-based sulfur-resistant shift catalyst is then carried out. Catalytic reactor A is treated upflow with a gas mixture comprising hydrogen at a flow rate of 8.5 Nl/h, carbon monoxide at 17 Nl/h, water at 0.33 cm³/min and nitrogen at 26 Nl/h at a pressure of 20 bars (2 MPa). The molar ratio H₂O/CO is of 1.44 and the residence time is of 38 seconds. An activating agent is then injected upflow in the gas mixture. The activating agent is either hydrogen sulphide (H₂S) or dimethyl disulphide (DMDS). In the case the activating agent is DMDS, the DMDS flow rate is set to 1 cm³/h. In the case the activating agent is H₂S, the H₂S flow rate is set to 0.5 Nl/h. The temperature of the gas entering the catalytic reactor A is maintained at 310° C.

The CO and CO₂ concentrations of the gaseous flow are measured with an infra-red spectroscopic analyzer connected to the outlet of the catalytic reactor A in order to determine the CO conversion and the CO₂ yield.

In the case the activating agent is H₂S, a CO conversion rate of 92% and a CO₂ yield of 95% are obtained, such a rate reflecting good performance of the water-gas shift reaction.

The same conversion rate is obtained when DMDS is used as the activating agent. Therefore, DMDS is as efficient as H₂S to activate the sulfur-resistant shift catalyst for the water-gas shift reaction.

The process using at least one compound responding to formula (I) as defined in the present invention instead of gaseous hydrogen sulphide is therefore as efficient, safer and easier to implement.

1-9. (canceled)

10. A process for producing a hydrogen-enriched synthesis gas by a catalytic water-gas shift reaction, the process comprising:
continuously injecting a raw synthesis gas with at least one compound of formula (I): 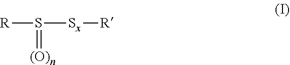
wherein:
R is selected from a linear or branched alkyl radical containing from 1 to 4 carbon atoms, and a linear or branched alkenyl radical containing from 2 to 4 carbon atoms,
n is equal to 0, 1 or 2,
x is an integer selected from 0, 1, 2, 3 or 4, and
R′ is selected from a linear or branched alkyl radical containing from 1 to 4 carbon atoms, a linear or branched alkenyl radical containing from 2 to 4 carbon atoms and, only when n=x=0, a hydrogen atom, followed by
reacting in a reactor the injected raw synthesis gas in a catalytic water gas shift reaction to produce hydrogen-enriched synthesis gas,
wherein the catalytic water gas shift reaction is carried out in the presence of a sulfur-resistant shift catalyst,
wherein the raw synthesis gas comprises water and carbon monoxide in a molar ratio of water to carbon monoxide of at least 1:1, and
wherein the raw synthesis gas is not injected with hydrogen sulphide.

11. The process according to claim 10, wherein the compound of formula (I) is selected from dimethyl disulphide and dimethyl sulfoxide.

12. The process according to claim 10, wherein the catalytic water-gas shift reaction is carried out in a reactor with an inlet gas temperature of at least 260° C.

13. The process according to claim 10, wherein the compound of formula (I) is continuously injected at a flow rate of 0.1 NI/h to 10 Nm³/h.

14. The process according to claim 10, wherein the sulfur-resistant shift catalyst is a cobalt and molybdenum-based catalyst.

15. The process according to claim 10, wherein the sulfur-resistant shift catalyst comprises an alkali metal.

16. The process according to claim 10, wherein the catalytic water-gas shift reaction is carried out at a pressure of at least 10 bar.

17. The process according to claim 10, wherein the raw synthesis gas comprises water and carbon monoxide in a molar ratio of water to carbon monoxide of at least 1:1.2.

18. The process according to claim 10, wherein the residence time of the raw synthesis gas in the reactor ranges from 20 to 60 seconds.

19. The process according to claim 10, wherein the sulfur-resistant shift catalyst is dried before the water-gas shift reaction with an inert gas at a temperature of 20 to 200° C. for 1-10 hours, followed by treatment with a gas stream containing hydrogen gas and at least one compound of formula (I) at temperatures above 150° C.

20. The process according to claim 10, wherein conversion rate of the carbon monoxide in the water-gas shift reaction is of at least 60%.
